(19) United States
(12) Patent Application Publication
(10) Pub. No.: US 2012/0290495 A1
(43) Pub. Date: Nov. 15, 2012

(54) SYSTEM AND METHOD FOR ESTABLISHING TRANSSHIPMENT OF A PRODUCT BETWEEN STOCKING LOCATIONS

(75) Inventors: Srinivas NARASIMHAMURTHY, Bangalore (IN); Durga Prasad MUNI, Aska (IN); Lokendra Shastri, Kensington, CA (US)

(73) Assignee: INFOSYS TECHNOLOGIES LIMITED, Bangalore (IN)

(21) Appl. No.: 13/103,431

(22) Filed: May 9, 2011

(51) Int. Cl. G06Q 10/00

(52) U.S. Cl. 705/330

(57) ABSTRACT

The disclosed embodiment relates to methods, systems, and computer readable code for establishing transshipment of a product between stocking locations. The exemplary method comprises the steps of transmitting a transshipment request to at least one supplier requesting transshipment of a product, the transshipment request including information regarding the product and specifying a reward for transshipment of the product, receiving a handshake request from one of the suppliers in response to the transshipment request, the handshake request indicating the willingness of the one of the suppliers to provide the product as specified in the transshipment request and including information regarding the transshipment; and accepting the handshake request, thereby initiating transshipment of the product from the one of the suppliers in accordance with the accepted handshake request. The method may further comprise determining whether to accept the handshake request based on the information regarding the transshipment included in the handshake request.

### FIELD OF THE INVENTION

The invention relates to a system and method for establishing transshipment of a product between stocking locations.

### BACKGROUND

Transshipment is the transfer of products between stocking or retail locations (i.e. movement of goods between locations at the same or similar echelon). Benefits of transshipment include utilization of a secondary source of replenishment leading to better customer service, easier to transship goods than to replenish from supplier, transshipment can be done more frequently than replenishment from supplier, transshipment allows each stocking location to be more responsive to customer demands, and cost savings because transshipment is faster and cheaper than emergency shipments from a central depot. Transshipment also provides a mechanism to correct discrepancies between locations' observed demand and their inventory while leading to cost reductions and improved customer service without increasing system-wide inventories. Transshipment is also cheaper and more feasible than simply increasing number of shipments from supplier (due to say, high fixed costs of replenishments).

Transshipment is an important tool in commerce when customer demand for a product needs to be met on a daily basis, in contrast to replenishment from suppliers, which typically occurs on a periodic basis, for example, monthly production/distribution from China). Transshipment can also act as a hedge against the risk of supply disruption and delays, for example, during disruptive weather (hurricanes, snowfall) or during other business impedances, for example, employee strikes at production facilities.

Transshipment typically occurs in all types of retail outlets including, for example, auto-parts/service chains, footwear chains, book or office supply selling chains, clothing and fashion goods stocking chains, and all manners of industrial manufacturing plants.

In most supply-chain contexts, replenishment from the central supplier is often unwieldy, infrequent and expensive, involving fixed replenishment costs. There is often a minimum size for such shipments and typically require a lead-time which is uncertain. In extreme cases, there is a risk of supply disruption and delays due to varied factors such as hurricanes and strikes in production facilities. Thus stocking locations not only have to plan ahead of time for such shipments but also need an alternate source of replenishment which is flexible and responsive to sudden short-term (e.g: daily) demand fluctuations. Increasingly transshipment, that is, movement of goods between locations at the same echelon, is being seen as an important secondary and flexible avenue for building up inventory to meet such demand fluctuations. On the other hand, at other stocking locations, it allows for eliminating excess inventory in anticipation of a reduction in demand. Thus transshipment allows stocking locations to be more responsive to customer demands, leading to improved customer service and an overall reduction in total costs.

In many business contexts such as retail chains, turning away customers due to lack of product inventory is unacceptable and is only a last resort, due to the loss of profit opportunities and more importantly the loss of customer goodwill. In such scenarios, pre-emptive transshipments from the stocking locations of their chain peers provide an effective mechanism for correcting discrepancies between the locations' observed demand and their available inventory. For example, consider Pep-boys, an auto-service chain in the US. Suppose a customer walks into a location A for a auto-part. If location A does not hold inventory of the part, the customer might not be willing to wait until it is transshipped from location B, which might take at least a day. Thus it would be preferable for location A to pre-empt this adverse scenario by requesting for transshipment prior to the customer arriving at location A. This entails a clever forecasting of the short-term demands at location A. Any shortfalls must then be bridged via transshipment from peer locations giving due consideration to the costs of transshipments.

In current supply chain practice, the importance of transshipment is still underappreciated. Consequently, stocking locations lack a coordinated way of responding to their fluctuating customer demands. Notably most transshipments happen after demands are realized and most customers are generally not willing to wait until the transshipments are effected. This critical flaw in current practice needs to be addressed while developing a suitable coordination scheme for the pool of stocking locations. In other words, there is a need to sense impending shortfalls in inventories and intelligently request for transshipment prior to the occurrence of demand. Yet another hindrance to effective transshipment in current practice is the lack of clear incentives for transshippers, leading to reluctance of the parties to transship. Hence the full potential of transshipment in reducing costs and improving customer service is yet to be harnessed.

Publications related to transshipment have addressed highly restrictive cases such as dealing with the case of two retailers or problems with multiple identical retailers. (See Robinson L. W. 1990. Optimal and approximate policies in multiperiod, multilocation inventory models with transshipments. Operations Research 38: 278-295. and Jonsson H. and E. A. Silver. 1987. Analysis of a two-echelon inventory control system with complete redistribution. Management Science 33: 215-227.) In addition, transshipment schemes have been proposed for the general case of a pool of stocking locations which are replenished from a central supplier, with each stocking location carrying their own cost structure and demand parameters. (See Herer, Y. T., Tzur, M., and Yucesan, E., 2006. The multi-location transshipment problem, IIE Transactions 38: 185-200., Deniz Ozdemir, Enver Yucesan, Yale T. Herer, Multi-Location Transshipment problem with capacitated production and lost sales, Proceedings of the 2006 winter simulation conference., and Herer, Y. T. and Tzur, M. (2003) Optimal and heuristic algorithms for the multi-location dynamic transshipment problem with fixed transshipment costs., IIE Transactions, 5(5), 419-432.). These works primarily deal with transshipment in the context of replenishment (inventory ordering) policies and solves an optimization problem, modeled on a network flow representation. However, most literature in this field relates to the problem of transshipments that occur after the demand is realized but before they are satisfied.

The proposed techniques in literature are difficult to adopt by industry practitioners. Specifically, there are a few key concerns in the advocated approaches:

1) Individual transshippers less inclined to comply with group-level decisions which optimize overall system costs.

2) Traditional approaches may force transshipment decisions which are myopic, in the sense, that the decisions optimize system costs only for the current time period. But in reality transshipment decisions incur cumulative costs, over time.

3) Traditional approaches assume a certain optimal base stock policy to be followed by each member of the transshipping pool. In reality, the replenishment policies followed by each member of the transshipment pool, are likely to be varied. Expecting each member to comply with a certain replenishment policy is very unrealistic.

4) Traditional approaches assume that the transshipment decision is made after the demand is realized in that time period. This is somewhat restrictive in many domain contexts where the demand needs to be satisfied almost immediately and customers may not be able to wait until the transshipment happens. This important gap needs to be addressed in the optimization based literature on transshipment

5) No incentives (rewards) for transshipment by transshipping parties. When holding costs are low, parties might retain excess inventory to satisfy their local demands and might be reluctant to transship.

In existing transshipment scheme, transshipment is generally done ad-hoc in response to customer demand for a specific product, and it is not considered to be a mainstream vehicle for replenishing stocks or building up inventories. Furthermore, there are no direct incentives for transshipment in current schemes.

For example, in existing transshipment supply schemes, pools of stocking locations are periodically replenished from a central depot. In some cases, transshipment of products is dealt with in the context of replenishment (inventory ordering). This system hinders the flow of products through the product distribution network because unexpected surges in demand cannot be addressed quickly enough to satisfy the needs of consumers.

The existing technologies are not suited for adoption by industry practitioners. Some key limitations include the following:

1. Individual transshippers are required to comply with group-level decisions which optimize overall system costs.

2. Existing approaches force transshipment decisions which are myopic, in the sense, that the decisions optimize system costs only for the current time period. But in reality transshipment decisions incur cumulative costs, over time.

3. Existing technologies assume a certain optimal base stock policy to be followed by each member of the transshipping pool. In reality, the replenishment policies followed by each member of the transshipment pool, are likely to be varied. Expecting each member to comply with a certain replenishment policy is very unrealistic.

4. Existing techniques significantly assume that the transshipment decision is made after the demand is realized in that time period. This is quite restrictive because the demand needs to be satisfied almost immediately and customers may not be able to wait until the transshipment happens.

5. No incentives for transshipment by transshipping parties. When holding costs are low, parties might retain excess inventory to satisfy their local demands and might be reluctant to transship.

### SUMMARY

The disclosed embodiment relates to a method for establishing transshipment of a product between stocking locations. The method preferably comprises the steps of transmitting, by a computing device, a transshipment request to at least one supplier requesting transshipment of a product, the transshipment request including information regarding the product and specifying a reward for transshipment of the product, receiving, by a computing device, a handshake request from one of the suppliers in response to the transshipment request, the handshake request indicating the willingness of the one of the suppliers to provide the product as specified in the transshipment request and including information regarding the transshipment; and accepting, by a computing device, the handshake request, thereby initiating transshipment of the product from the one of the suppliers in accordance with the accepted handshake request. The method may further comprise determining, by a computing device, whether to accept the handshake request based on the information regarding the transshipment included in the handshake request.

The disclosed embodiment further relates to a system for establishing transshipment of a product between stocking locations. The system preferably comprises a computing device configured to transmit a transshipment request to at least one supplier requesting transshipment of a product, the transshipment request including information regarding the product and specifying a reward for transshipment of the product, a computing device configured to receive a handshake request from one of the suppliers in response to the transshipment request, the handshake request indicating the willingness of the one of the suppliers to provide the product as specified in the transshipment request and including information regarding the transshipment, and a computing device configured to accept the handshake request, thereby initiating transshipment of the product from the one of the suppliers in accordance with the accepted handshake request. The system may further comprise a computing device configured to determine whether to accept the handshake request based on the information regarding the transshipment included in the handshake request.

In addition, the disclosed embodiment relates to computer-readable code stored on a computer-readable medium that, when executed by a processor, performs a method for establishing transshipment of a product between stocking locations. The method comprises transmitting, by a computing device, a transshipment request to at least one supplier requesting transshipment of a product, the transshipment request including information regarding the product and specifying a reward for transshipment of the product, receiving, by a computing device, a handshake request from one of the suppliers in response to the transshipment request, the handshake request indicating the willingness of the one of the suppliers to provide the product as specified in the transshipment request and including information regarding the transshipment, and accepting, by a computing device, the handshake request, thereby initiating transshipment of the product from the one of the suppliers in accordance with the accepted handshake request. The method may further comprise determining, by a computing device, whether to accept the handshake request based on the information regarding the transshipment included in the handshake request.

The disclosed embodiment further provides that the information included in the transshipment request may include information identifying the product, information specifying the quantity of product requested for transshipment, and the like In addition, the reward specified in the transshipment request may indicate the reward payable to the supplier upon transshipment of the product. Moreover, the information regarding the transshipment included in the handshake request may specify the cost of transshipment of the product.

### BRIEF DESCRIPTION OF THE DRAWINGS

FIG. 1 illustrates a production facility without transshipment.

FIG. 2 illustrates a production facility with transshipment.

FIG. 3 illustrates a production facility in which requesting nodes request transshipment from potential transshipping nodes.

FIG. 4 illustrates a production facility in which transshipping nodes initiate handshakes with specific requesting nodes.

FIG. 5 illustrates a production facility in which requesting nodes accept handshakes from specific transshipping nodes.

FIG. 6 illustrates a production facility in which transshipment occurs between transshipping nodes and requesting nodes.

FIG. 7 illustrates requests for transshipment received by a potential transshipping node, and the related rewards offers.

FIG. 8 illustrates handshake offers received by a requesting node, and the related transport costs.

FIG. 9 illustrates handshake offers received at a requesting node, related transport costs, and handshake acceptances to specific transshipping nodes.

FIG. 10 illustrates an overview of the system architecture of the disclosed embodiment.

FIG. 11 is a flow chart of an exemplary method of the disclosed embodiment.

FIG. 12 illustrates the costs with different values of twf (transshipment willingness factor) as explained in Example 1.

FIG. 13 illustrates the reduction in total costs with various values for a as explained in Example 2.

FIG. 14 illustrates an exemplary computing device useful for implementing systems and performing methods disclosed herein.

### DETAILED DESCRIPTION

The disclosed embodiment addresses the disadvantages of the existing transshipment methods by providing effective transshipment among stocking locations at the same echelon in a supply chain. It improves over existing methods along multiple dimensions, as listed below:

1) Independent decision-making by the transshippers, not requiring any group-level compliance.

2) Incentives for transshipping parties: As part of the protocol/decision-making processes of the disclosed embodiment, rewards are given to transshipping parties on each transshipment.

3) Transshipment decisions taken before demand is realized: Since the disclosed embodiment optionally makes pre-emptive transshipments, there is a strong likelihood of meeting the realized demands.

4) Flexible replenishment policies: The disclosed embodiment allows each individual party in the group to use any replenishment policy that best suits their interests.

5) Long-term decision making: The disclosed embodiment provides a sound basis for independent decision-making leading to creation of long term value.

The disclosed embodiment makes these advantages a reality by providing a decentralized protocol and decision-making technique for carrying out transshipments among stocking locations of, for example, retailers serving distinct customers. This transshipment strategy allows for independent decision-making, without the need to coordinate replenishment. Rewards provided by the model provide a direct incentive to transshippers to offload their excess stocks to other locations with deficits, encouraging greater transshipment and allowing the latter to reduce expensive supplier replenishment costs and simultaneously improve profitability by servicing more customers. The disclosed embodiment reduces costs associated with replenishment from the central supplier and improves customer service and thus profitability for the stocking locations.

In contrast with existing transshipment methods, which use network flow representations and linear prediction based methods for achieving the transshipment, the disclosed embodiment provides an independent decision-making approach which is applied through the use of novel protocols. The protocols and methods described herein establish one-to-one connections between transshipping nodes and requesting nodes, based on rewards given and transshipment costs (i.e. transport costs).

In addition, the disclosed embodiment provides regret based decision-making techniques which make the ultimate transshipment quantity decisions based on the connections established by the protocol. Specifically, by providing rewards and other incentives for transshipment, regret experienced by transshippers can be minimized or eliminated. In the regret framework, the objective is for each individual transshipper to make decisions based on algorithms which ‘minimize’ their individual regret. Also known as ‘zero regret’ algorithms, these algorithms bound the performance of the regret with time. Significantly, these algorithms which support online decision making, make no use of any statistical assumptions. Instead the decision-making is carried out based on rewards obtained. In the transshipment context, the main incentive for a transshipper (to transship) lies in the reward given by the counterparty (transshippee).

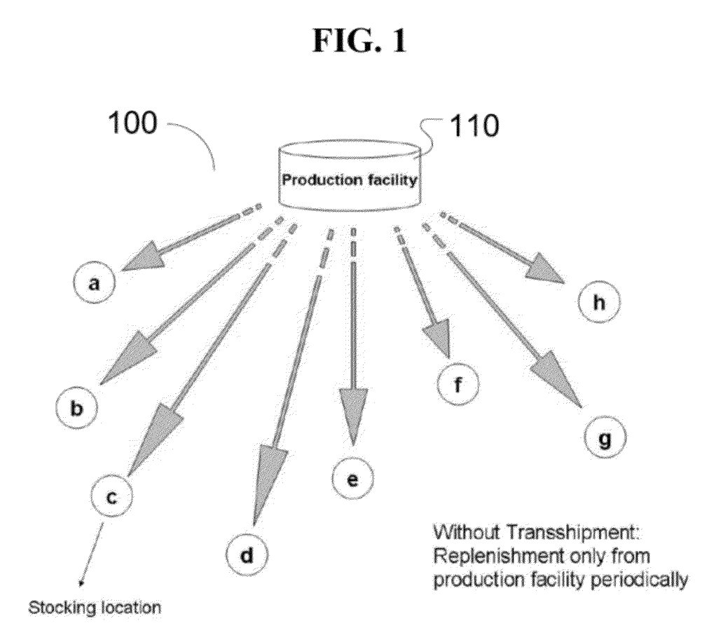

Referring now to the figures, FIG. 1 illustrates a traditional production facility scheme 100 that doesn't utilize transshipment. Specifically, production facility 110 acts as a supply house, distributor, production facility, or other distributive entity that supplies or replenishes stocking locations a-h with goods periodically.

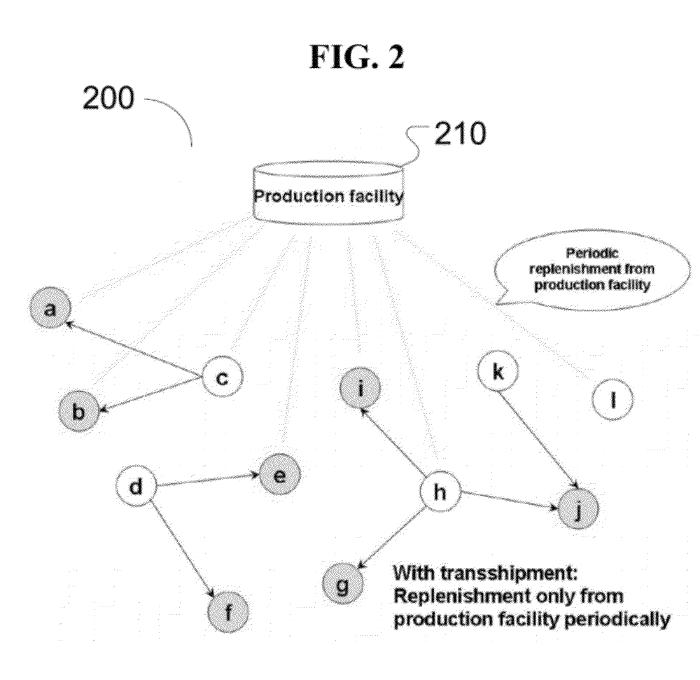

FIG. 2 illustrates a production facility scheme 200 that utilizes transshipment. Specifically, production facility 210 is not relied upon to provide constant goods or products to stocking locations a-l. Instead, each stocking location is capable of transshipping goods to the other stocking locations, and production facility 210 is only used for periodic replenishment. For example, FIG. 2 illustrates transshipment between stocking location c and stocking locations a and b, stocking location d and stocking locations e and f, stocking location h and stocking locations g, 200i, and j, and stocking location k and stocking location j. Stocking location l is not involved in transshipping in this illustration. Furthermore, stocking location j is receiving transshipments from both stocking location h and k. In this embodiment, stocking locations c, d, h, and k are transshipping nodes (also referred to as transshippers or suppliers), and stocking locations a, b, e, f, g, i, and j are requesting nodes (also referred to as transshippees or requestors).

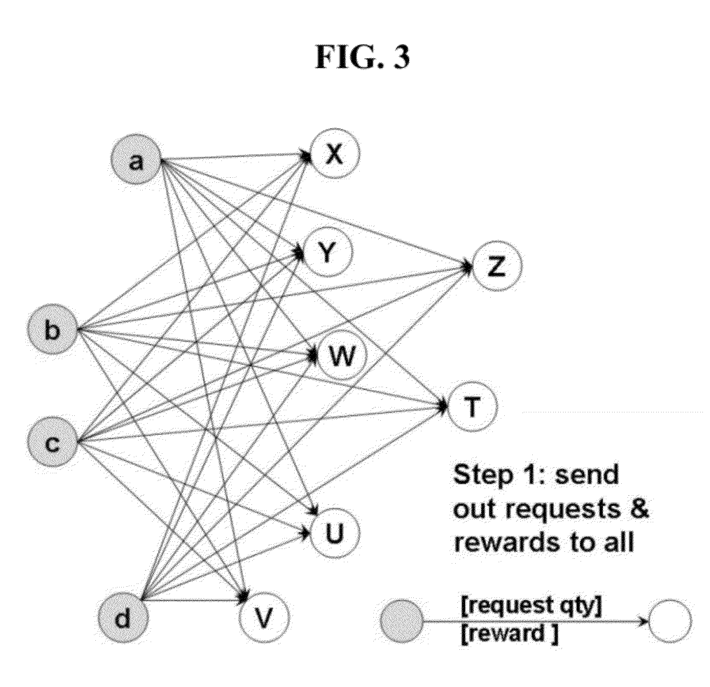

FIG. 3 illustrates a production facility according to an embodiment of the disclosed embodiment in which requesting nodes request transshipment from potential transshipping nodes. Specifically, stocking locations a-d, which are requesting nodes, each transmit one or more transshipment requests to stocking nodes T-Z, which are transshipping nodes. The transshipment requests preferably include information regarding the product and specifying a reward for transshipment of the product. This information can include, for example, information identifying the product, information specifying the quantity of product requested for transshipment, and the like. The reward specified in the transshipment request may indicate the reward payable to the supplier upon transshipment of the product. In FIG. 3, the information specifies a desired quantity of goods for transshipment and a reward.

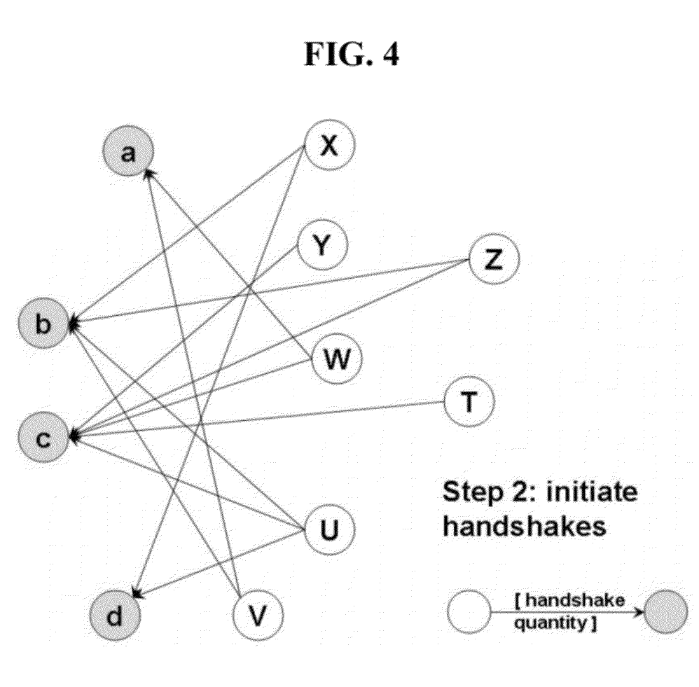

FIG. 4 illustrates a production facility in which transshipping nodes initiate handshakes with specific requesting nodes. Specifically, stocking nodes T-Z, which are transshipping nodes, initiate handshakes with one or more of stocking nodes a-d, which are requesting nodes. For example, stocking node X transmits a handshake request to stocking nodes b and d in response to the transshipment requests sent by stocking nodes b and d described above with reference to FIG. 3. The handshake requests indicate the willingness of the respective transshipping node to provide the product(s) as specified in the transshipment request to the requesting node, and preferably includes further information regarding the transshipment. This information can include, for example, the quantity of goods available from that transshipping node, information specifying cost of transshipment of the product from that specific transshipping node to the requesting node, and the like.

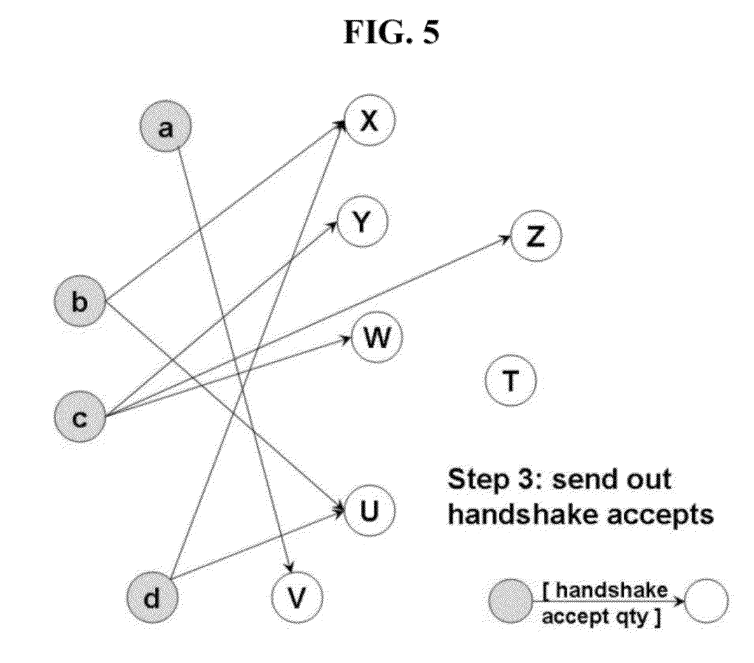

FIG. 5 illustrates a production facility in which requesting nodes accept handshakes from specific transshipping nodes. Specifically, in FIG. 5, stocking locations a-d each accept handshake requests from one or more of stocking locations U-Z. (Note that none of stocking locations a-d accepted a handshake request from stocking location T). For example, stocking location b accepted the handshake requests offered by stocking locations X and U. The acceptance of a handshake offer may include information regarding the transshipment, for example, information specifying the quantity of goods accepted from that specific transshipping node.

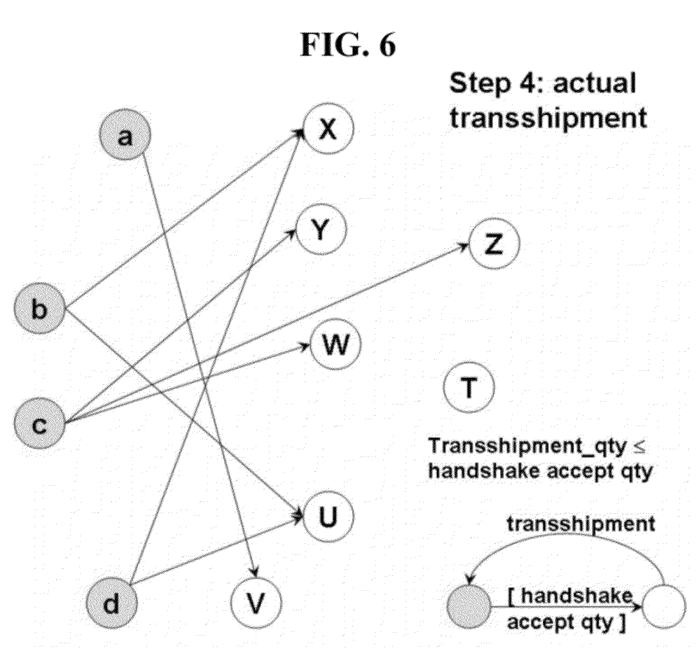

The acceptance of a handshake request preferably initiates the actual transshipment of the product from the one of the suppliers in accordance with the accepted handshake request. FIG. 6 provides an overview of the steps of handshake acceptance and the resulting transshipment between transshipping nodes and requesting nodes. Specifically, after stocking locations a-d accept their respective handshake requests, stocking locations U-Z can begin sending the requested goods to their respective requesting nodes.

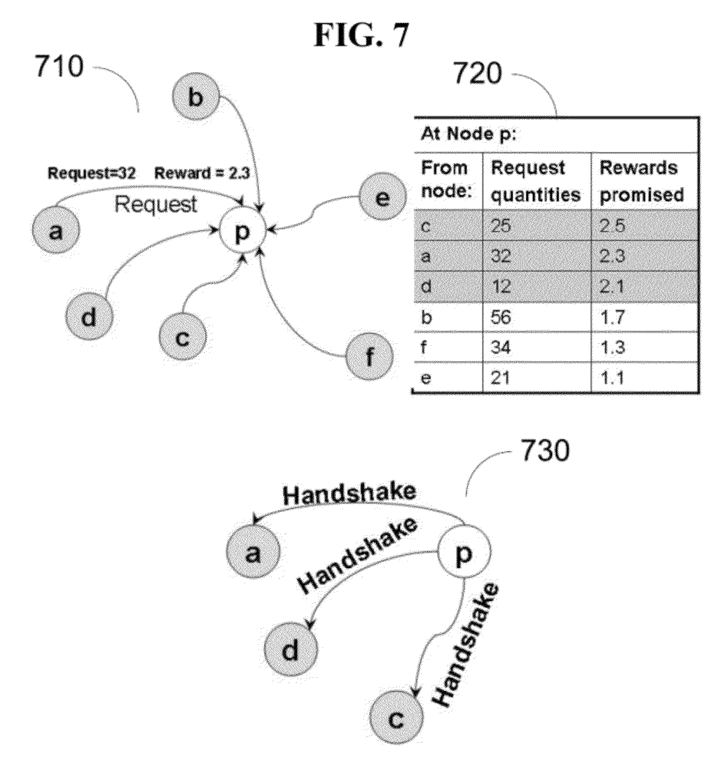

To further elaborate on the above steps, FIG. 7 illustrates exemplary requests for transshipment received by a potential transshipping node, and the related rewards offers. Specifically, according to diagram 710, transshipping node p receives transshipment requests from requesting nodes a-f. In this example, each transshipment request includes information regarding the requested quantity and information specifying the reward for transshipment (i.e. requesting node a specifies a requested quantity of 32 units with a reward of 2.3). Table 720 summarizes the quantities requested and the rewards offered by each requesting node. Transshipping node p can use this information to determine which transshipment requests to accepts. Typically, the requests with the highest reward will be chosen. The transshipping nodes can then transmit handshake requests to those requesting nodes. In diagram 730, transshipping node p transmits handshake requests to requesting nodes a, c, and d, which offered rewards of 2.3, 2.5, and 2.1, respectively.

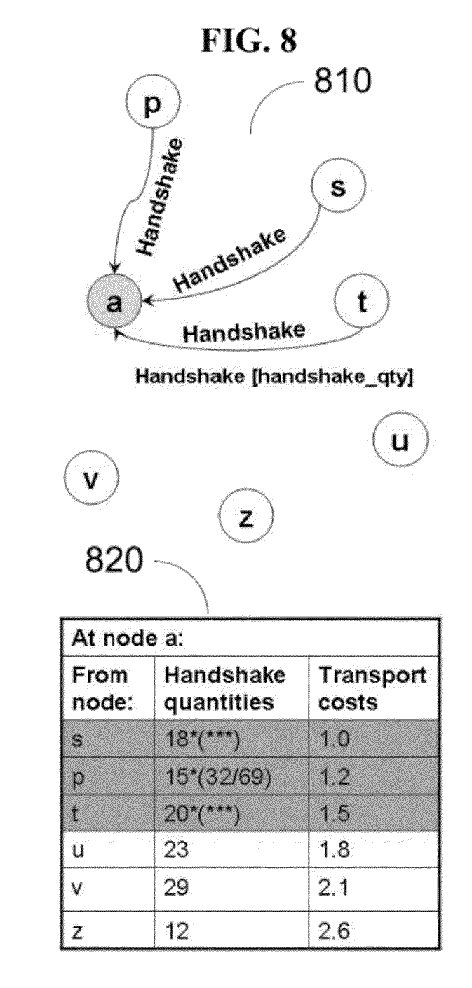

FIG. 8 illustrates handshake offers received by a requesting node, and the related transport costs. Specifically, according to diagram 810, requesting node a receives handshake requests from transshipping nodes p, s, and t. Transshipping nodes u, v, and z did not submit handshake requests to requesting node a. Each handshake request indicates a quantity available and specifies the transport costs of any transshipment. Table 820 summarizes this information. Requesting node a can use this information to decide which of the handshake requests to accept, for example, those with the appropriate quantities available, or those with the lowest transport costs.

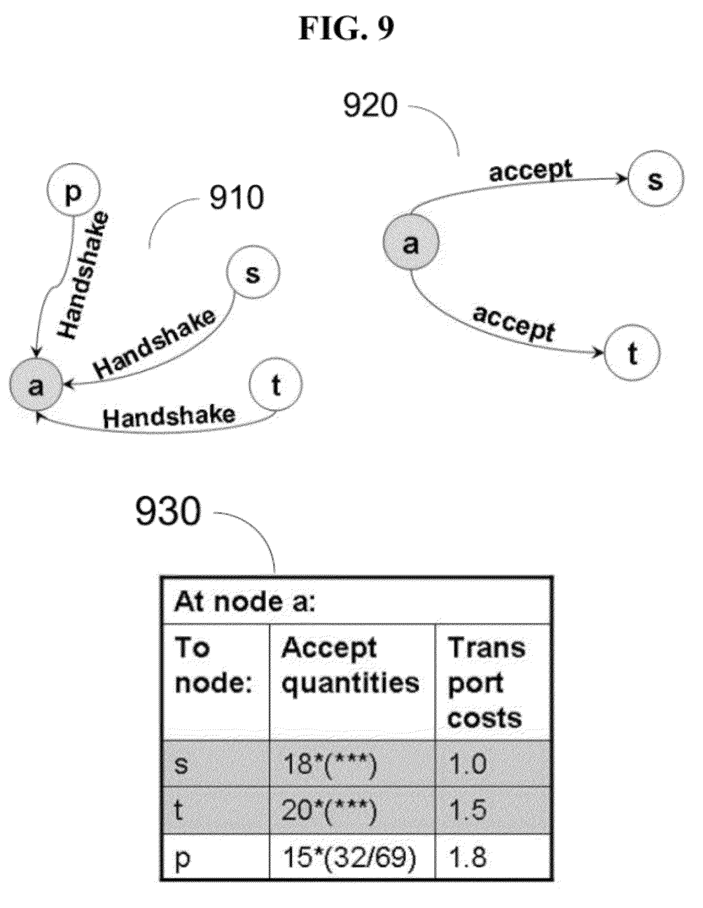

FIG. 9 illustrates handshake offers received at a requesting node, related transport costs, and handshake acceptances to specific transshipping nodes. Specifically, according to diagram 910, requesting node a receives handshake requests from transshipping nodes p, s, and t. The requesting node then determines whether to accept any of the handshake requests based on the information regarding the transshipment included in the handshake request. Diagram 920 shows that requesting node a accepts the handshake requests from transshipping nodes s and t, and table 930 summarizes the acceptance with the quantities accepted and any related transport costs. For example, requesting node a accepted 18 units from transshipping node s, with a transport cost of 1.0, and 20 units from transshipping node t with a transport cost of 1.5.

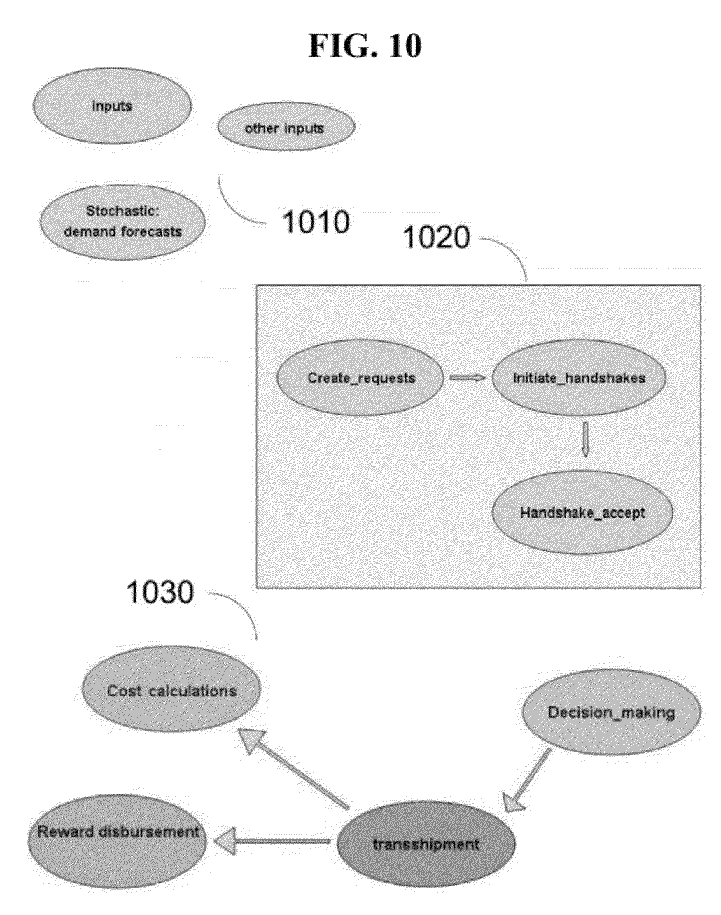

FIG. 10 illustrates an overview of the system architecture of the disclosed embodiment. Overall, various factors can be taken under consideration when deciding whether transshipments are needed. For example, according to diagram 1010 these factors can include demand predictions or other inputs. After it has been determined that a transshipment is needed, the primary decision making steps outlined above are (1) creation/transmission of transshipment requests by requesting nodes, (2) handshake initiations by transshipping nodes, and (3) handshake acceptances by requesting nodes. See diagram 1020. After this decision making process is completed, diagram 1030 illustrates that transshipment occurs, and subsequently, cost calculations regarding transport costs, etc. are completed and rewards, if any, are distributed to the transshipping nodes.

To explain further, consider the following example: Suppose there is one supplier and N stocking locations (a.k.a. nodes) facing customer demand. The demand distribution at each retailer in a period is preferably assumed to be known and stationary over time. The random demands occuring at each stocking location is met by the inventory and any unmet demand is lost incurring shortage cost at the node. Each stocking location independently replenishes to an order-up-to level at regular intervals from the supplier who has no capacity constraints. It can be assumed that all lateral transshipments are allowed and each transshipment incurs transport cost to the transshippee, while the transshipper receives rewards from the transshippee. Further, each stocking location is assumed to incur inventory holding costs. In this example, a time-horizon divided into identical periods can be assumed. In each period, the following sequence of events occurs, at each stocking location: any replenishment followed by transshipment decisions followed by any (in)outbound transshipments and then satisfaction of demands occuring at the node. The time to make the transshipments is negligible in comparison to the length of the period.

To describe the system, the following notations are adopted:

N = number of stocking locations
dᵢ = actual demand at location i in an arbitrary period
uᵢ (t) = mean demand at location i, at time t
hᵢ = holding cost incurred at location i per unit held per period
pᵢ = penalty cost incurred at location i per unit shortage
rᵢ = transshipment request reward (per unit) given by
transshippee i to its transshipper
tᵢⱼ = transshipment cost (per unit) incurred by j on receiving a
transshipment from i
Sᵢ = order-up-to level for replenishment at node i
rep_inti = replenishment interval at node i
twf = transshipment willingness factor
tuf = transshipment uncertainty factor

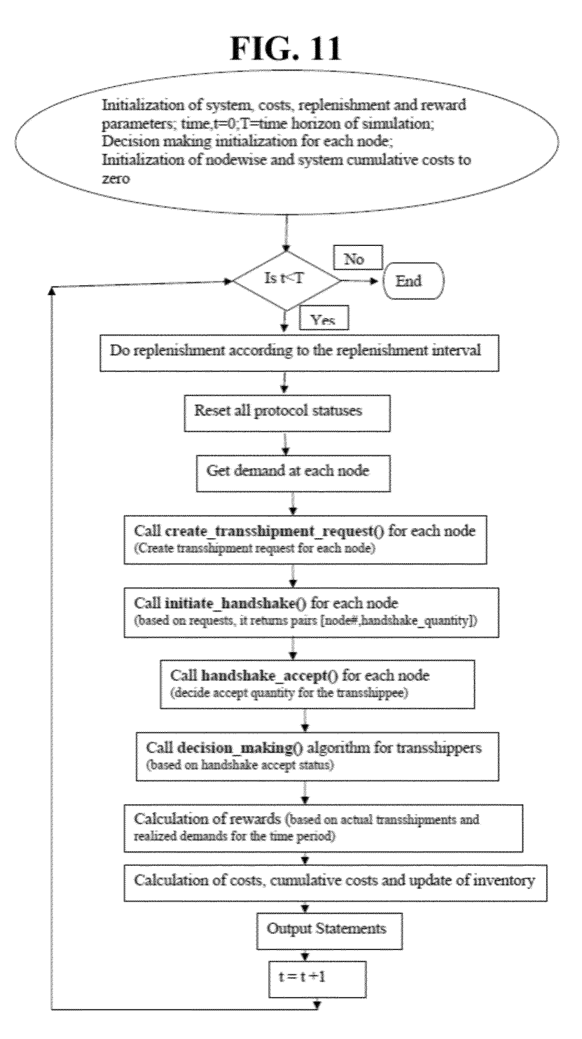

As described above, the methods of the disclosed embodiment are designed such that each transshippee prefers transshippers with lower transport costs and transshippers prefer transshippees who give away greater rewards as incentives. FIG. 11 outlines the more detailed ememplary method described below.

Each transshipment request communicates a need for transshipment (to avoid shortages locally), and also preferably reflects the quantities needed (for current demand/for inventory), considers the uncertainties involved (i.e. parties may or may not initiate handshake, “i” may/may not accept the handshake, and parties may/may not trans-ship), and considers other information (i.e. inventory levels (of other parties), transshipment costs charged by each party, etc.).

In summary, the subroutine create_trans-shipment_request(i) preferably completes the following steps:

a) Decides whether any node ‘i’ is a transshipper or transshippee; and

b) For each transshippee, requests a certain quantity and publishes the reward (per unit) he is going to give to a transshipper on transshipment.

An exemplary subroutine create_trans-shipment_request(i) is as follows:

subroutine create_trans-shipment_request(i)
{

if inv(i) < β(t) ¹ * μᵢ(t) then

node(i) is a requester;
transshipment_request_quantity(i) = β * mean_demand −
inv(i);

else

node(i) is a transshipper;

end if
}

In response, each transshipper should consider various factors before initiating a handshake request including the opportunity of trans-shipment to multiple parties, the reward opportunities from each, the local inventory position/current demand/forecast, the probability of acceptance, and other relevant information (i.e. inventory levels of all parties, forecasts of other parties, etc.)

In summary, for every transshipper i, subroutine initiate_handshake(i) preferably completes the following steps:

a) On receipt of requests from every transshippee, transshipper ‘i’ prioritizes the requests in descending order of reward values;

b) Transshipper ‘i’ decides the total quantity that he is willing to transship; and

c) Transshipper ‘i’ apportions (handshake) that quantity among the top half reward givers.

Thus, in order to get more transshippers to handshake, a transshippee will have to give greater rewards as compared to his peers. After the completion of initiation of handshakes, any transshippee ‘i’ confirms the parties from whom he will accept transshipment. His primary concern now is to choose transshippers based on transport costs as well as their handshake quantities.

An exemplary subroutine initiate_handshake(i) is as follows:

subroutine initiate_handshake(i)
{

V1: list the requests in descending order of rewards to be
given;
compute total_handshake_quantity = (inv(i) − β(t) * μᵢ(t))
* twf:
V2: select a top few requests from this sorted list;
if total_handshake_quantity < sum of request_quantities in
V2 then

apportion total_handshake_quantity among members of
V2

else

satisfy all request quantities of V2:
any remaining handshake quantity to be handshaked with
remaining requesters in descending order of rewards
given

end if

}

In response, each transshippee should consider various factors before accepting a handshake request including the probability that a particular party will indeed trans-ship, the trans-shipment costs for each party, and the like. Once a handshake is accepted, it is preferred that that acceptance is binding, and that transshipment will occur.

Thus, at each transshippee ‘i’, the subroutine handshake_accept(i) preferably completes the following steps:

a) On receipt of all handshakes from every transshipper, transshippee prioritizes transshippers by lowest transport cost;

b) Transshippee ‘i’ then decides on ‘accept quantities’ based on the net requested quantity as well as each handshake quantity. This approach leads to each transshippee preferring transshippers with lower transport costs and higher handshake quantities, ensuring ‘fair play’; and

c) Sends out confirmations to those transshippers from whom transshippee ‘i’ will accept transshipment.

As exemplary subroutine handshake_accept(i) is as follows:

subroutine handshake_accept(i)
{

V1: sort the list of received handshakes in ascending order
of transport costs;
V2: select a top few handshakes from this sorted list;
if transshipment_request_quantity < sum of
handshake_quantities in V2 then

apportion transshipment_request_quantity among mem-
bers of V2:

else

satisfy all handshake quantities of V2:
any remaining transshipment_request_quantity to be con-
firmed with remaining handshakers in ascending order of
transport costs;

end if

}

Having confirmed the transshippers from whom he will accept transshipment and the (maximum) quantities he will accept, each transshippee waits for the actual transshipments from each of the transshippers with whom he has confirmed acceptance.

Considering the advantages of regret decision-making described above, the problem of transshipment can be cast as a problem of repeated decision making in which the transshipment quantities are sampled. A regret based decision making algorithm is implemented at each node, during the periods that the node is a transshipper. Regret algorithms are preferably intended to provide two kinds of bounds on the performance of an individual party (transshipper). The first type of algorithm provides a bound on the expected regret. The second type of algorithm provides a confidence bound on the weak regret. Since the variance of the regret achieved by the first type is large, the latter modifies them by controlling the variance. The result is that a high probability bound holds for the latter type.

Continuing the example above, each transshipper ‘i’ uses subroutine decision-making-algorithm(i) to send out transshipments up to the extent of the maximum quantities acceptable to each. This concludes the transshipments for given period ‘t’, which occur before the actual realization of demand in period ‘t’.

As exemplary subroutine decision-making-algorithm(i) is as follows:

Parameters: Real γ ∈ (0, 1].
Initialization: wᵢ (1) = 1 for i = 1, . . . , K.
For each t = 1, 2, . . .

| | |
|---|---|
| 1) | Set |
| | ${p}_{i} ( t ) = ( 1 - γ ) \frac{{w}_{t} ( t )}{{\sum }_{j = 1}^{K} {w}_{j} ( t )} + \frac{γ}{K} i = 1 , . . . , K .$ |
| 2) | Draw iₜ randomly according to the probabilities |
| | p₁ (t), . . . , p_{K} (t). |
| 3) | Receive reward xᵢ_{ₜ} (t) ∈ [0, 1]. |
| 4) | For j = 1, . . . , K set |
| | \hat{x}ⱼ (t) = xⱼ (t)/pⱼ (t) if j = iₜ, |
| | = 0 otherwise. |
| | wⱼ (t + 1) = wⱼ (t) exp(γ\hat{x}ⱼ (t)/K) |

Transshipment_qty (node i to node j) = (iₜ/K) * handshake_accept_quantity
(node j to node i) [≦ handshake_accept_quantity (node j to node i)]

Though it is clear that the greedy action iₜ=K always delivers the highest rewards for this period, it might not be the best in terms of delivering high cumulative rewards or in terms of minimizing regret at the node.

To study the efficacy of the protocol and decision making as set forth above, the following experiments were conducted.

### EXAMPLE 1

### No Fixed Cost of Replenishment

For this example, the following parameters were assumed:

N=8

hᵢ=$ 0.2. ∀i=1, 2, . . . , N

pᵢ=$ 10, ∀i=1, 2, . . . , N

μᵢ=10-13 with uniformly distributed noise in [−3,3].

Sᵢ=110-124

rep_inti=6-14 periods

rᵢ=$1.7-$2.4

tᵢⱼ=$1.5-$2.4

These parameters were chosen assuming a product unit cost of $100, pᵢ=$10 which is assumed to be the sales margin foregone on a lost sale and the time period is 1 day.

The various cumulative system costs are reported in Table I. The parameters lead to a very big drop in shortage costs for a small investment in transport costs. There was a significant decrease in total costs as a benefit of transshipment.

The effects of the rewards are shown in Table II. When relative order is maintained, there is no difference in costs, for the protocol instance considered. We also performed an experiment when the reward offered by Node 3 was increased from the low value of 1.7 to the highest value of 2.45, the highest.

Table III shows only negligible change in its shortage and transport costs, since Node 3, is predominantly a transshipper, as seen from the high accumulation of rewards. At Node 1, when the reward was changed from 2.4 (highest) to 1.6 (lowest), a drastic reduction in the rewards given is observed, as Node 1 is predominantly a transshippee.

TABLE I
CUMULATIVE COSTS

| Costs | With Trans | No Trans |
|---|---|---|
| Shortage | 137411 | 5008006 |
| Holding | 5763411 | 5109476 |
| Transport | 1045516 | 0 |
| Total | 6945839 | 10117561 |

TABLE II
WITH DIFFERENT REWARDS AT NODE 3

| Costs | reward = 1.7 | reward = 2.42 |
|---|---|---|
| Shortage | 16700 | 17200 |
| Transport | 5200 | 5000 |
| Reward | 309000 | 307000 |

TABLE III
WITH DIFFERENT REWARDS AT NODE 1

| Costs | reward = 2.4 | reward = 1.6 |
|---|---|---|
| Shortage | 13000 | 13300 |
| Transport | 414000 | 426000 |
| Reward | −538000 | −356000 |

Transshipment willingness factors (twf) are used because transshippers are assumed to satisfy local demands first and only then offer excess inventory for transshipment to other transshippee or requesting nodes. However, each individual transshipper can control their transshipment quantity based on their risk-averseness, using the twf factor. For example, if twf<1, the transshipper is expecting a demand spurt (before next replenishment) and would like to conserve inventory for local demands. In contrast, if twf>1, the transshipper is expecting a slump in demand.

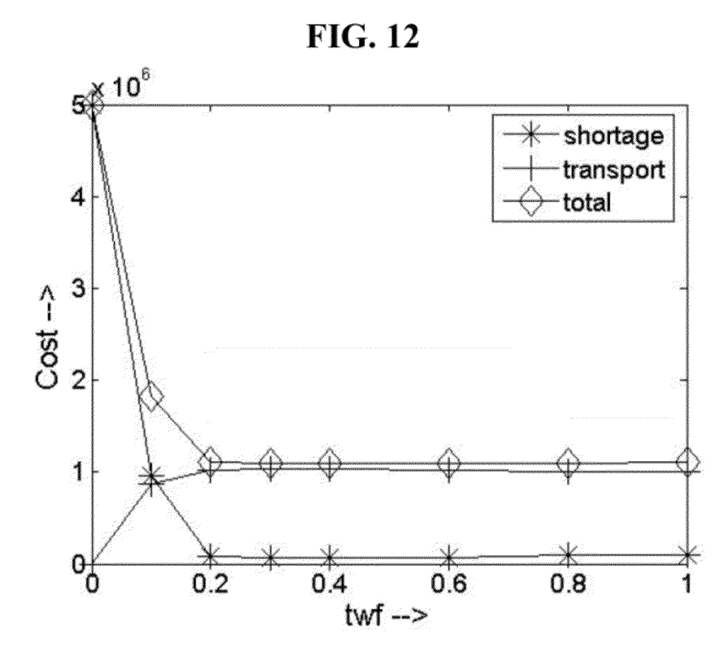

FIG. 12 graphically illustrates that the system costs (shortage and transport) are fairly constant over a wide range of twf values, and can be interpreted to mean that choosing twf values carefully is not a significant concern as long as it is not too low (<0.2).

### EXAMPLE 2

### Fixed Costs of Replenishment

Typically, every replenishment is accompanied by fixed costs to the node. Since transshipment provides an alternative to direct replenishment, it is sometimes possible to reduce fixed costs by choosing to transship instead of replenishing. The relevant trade-off is one of reducing fixed costs without significantly increasing shortage costs. One criterion would be to look at the ratio (Inv/Sᵢ) and choose to replenish if the inventory level falls below a certain threshold (α). In addition to the system parameters chosen in Example 1 set forth above, this example includes a node-wise fixed costs for replenishment. Specifically, it is assumed that the fixed cost of replenishment will be 100 (FCᵢ=100), which corresponds to roughly $1 per unit in fixed costs.

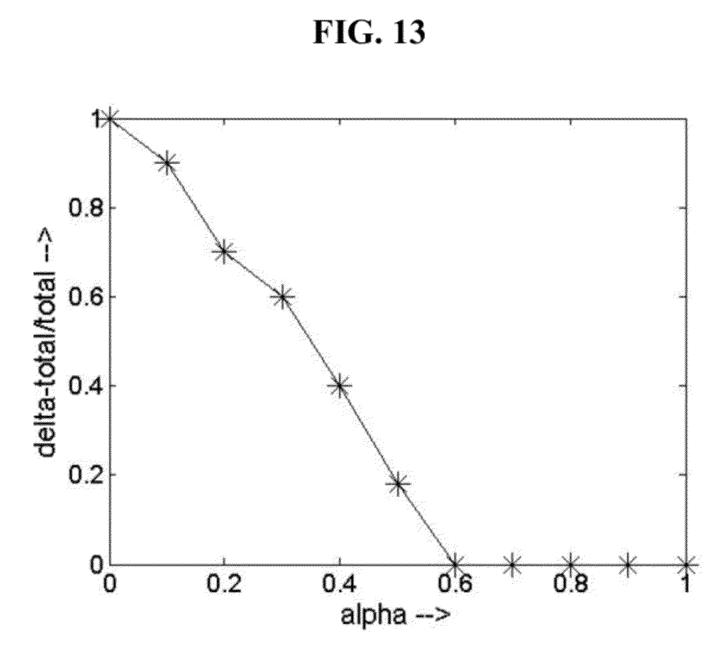

Based on the experiments performed for different values of a are shown below in Table IV and V. By using transshipment, no adverse effect on fixed costs were observed, but, of course, transshipment offers a drastic reduction in total costs as seen in Example 1. The biggest reduction in total costs (incl. fixed costs) was obtained at α=0.5. Hence by reducing a from 1.0 to 0.5, a marginal increase in shortage costs was observed, while a significant reduction in fixed costs was observed. FIG. 13 graphically illustrates the results of Example 2.

TABLE IV
α = 1

| Costs | with trans | without trans |
|---|---|---|
| Shortage | 104000 | 4984000 |
| Transport | 1005000 | 0 |
| Fixed cost | 4186000 | 4186000 |

TABLE V
α* = 0.5

| Costs | with trans | without trans |
|---|---|---|
| Shortage | 132000 | 4992000 |
| Transport | 1011000 | 0 |
| Fixed cost | 4026000 | 3856000 |

The above examples lead to the conclusion that transshipment can play a dual role by (a) improving customer service and, therefore, profitability, and (b) reducing fixed cost of replenishment.

As described herein, the disclosed embodiment relates to a decentralized protocol and decision making technique for carrying out transshipments among stocking locations serving distinct customers. This transshipment strategy allows for independent decision making, without the need to coordinate replenishment. Rewards are provided as a direct incentive to transshippers to offload their excess stocks to other locations with deficits, encouraging greater transshipment and allowing the latter to reduce expensive supplier replenishment costs and simultaneously improve profitability by servicing more customers.

The examples presented herein indicate a significant reduction in shortage costs, at a much smaller expense of transshipment costs, leading to a significant reduction in total costs of each individual stocking location and consequently that of the entire pool. The examples further indicate that the transshipment strategies of the disclosed embodiment reduce expensive replenishment related costs, including the fixed costs of replenishment. Thus, the disclosed embodiment provides techniques to both improve customer service and reduce costs. Moreover, the disclosed embodiment allows for transshipment flexibility. Using rewards as a motivator, transshipper nodes can get better offers for transshipment, and risk-averse transshippers can choose to reduce the transshipment quantities on offer, without significantly impacting the cost benefits derived from the scheme.

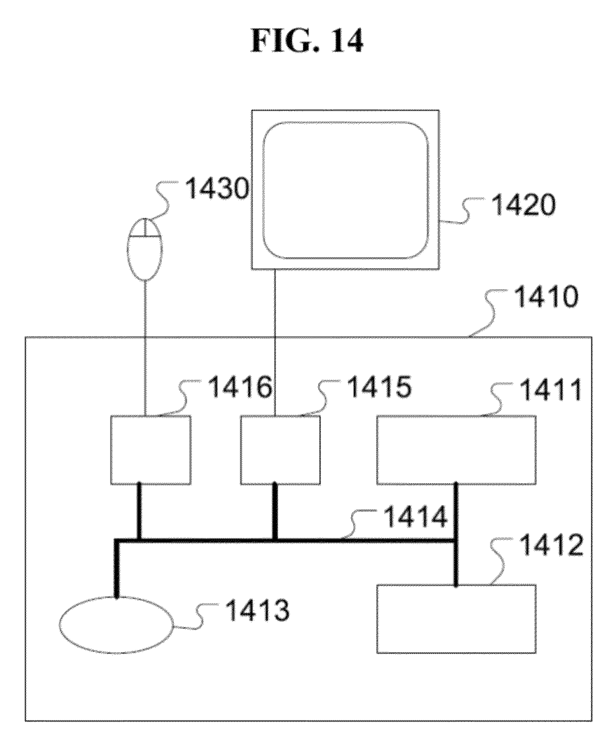

These embodiments may be implemented with any suitable hardware and/or software configuration, including, for example, modules executed on computing devices such as computing device 1410 of FIG. 14. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 1410 has one or more processing device 1411 designed to process instructions, for example computer readable instructions (i.e., code) stored on a storage device 1413. By processing instructions, processing device 1411 may perform the steps set forth in the methods described herein. Storage device 1413 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 1410 additionally has memory 1412, an input controller 1416, and an output controller 1415. A bus 1414 operatively couples components of computing device 1410, including processor 1411, memory 1412, storage device 1413, input controller 1416, output controller 1415, and any other devices (e.g., network controllers, sound controllers, etc.). Output controller 1415 may be operatively coupled (e.g., via a wired or wireless connection) to a display device 1420 (e.g., a monitor, television, mobile device screen, touch-display, etc.) in such a fashion that output controller 1415 can transform the display on display device 1420 (e.g., in response to modules executed). Input controller 1416 may be operatively coupled (e.g., via a wired or wireless connection) to input device 1430 (e.g., mouse, keyboard, touch-pad, scroll-ball, touch-display, etc.) in such a fashion that input can be received from a user (e.g., a user may input with an input device 1430 a dig ticket).

Of course, FIG. 14 illustrates computing device 1410, display device 1420, and input device 1430 as separate devices for ease of identification only. Computing device 1410, display device 1420, and input device 1430 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 1410 may be one or more servers, for example a farm of networked servers, a clustered server environment, or a cloud network of computing devices.

While systems and methods are described herein by way of example and embodiments, those skilled in the art recognize that the systems and methods for transshipment are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A method for establishing transshipment of a product between stocking locations, the method comprising:
transmitting, by a computing device, a transshipment request to at least one supplier requesting transshipment of a product, the transshipment request including information regarding the product and specifying a reward for transshipment of the product;
receiving, by a computing device, a handshake request from one of the suppliers in response to the transshipment request, the handshake request indicating the willingness of the one of the suppliers to provide the product as specified in the transshipment request and including information regarding the transshipment; and
accepting, by a computing device, the handshake request, thereby initiating transshipment of the product from the one of the suppliers in accordance with the accepted handshake request.

2. The method of claim 1, wherein the information included in the transshipment request includes information identifying the product.

3. The method of claim 1, wherein the information included in the transshipment request includes information specifying the quantity of product requested for transshipment.

4. The method of claim 1, wherein the reward specified in the transshipment request indicates the reward payable to the supplier upon transshipment of the product.

5. The method of claim 1, wherein the information regarding the transshipment included in the handshake request specifies the cost of transshipment of the product.

6. The method of claim 1, further comprising determining, by a computing device, whether to accept the handshake request based on the information regarding the transshipment included in the handshake request.

7. A system for establishing transshipment of a product between stocking locations, the system comprising:
a computing device configured to transmit a transshipment request to at least one supplier requesting transshipment of a product, the transshipment request including information regarding the product and specifying a reward for transshipment of the product;
a computing device configured to receive a handshake request from one of the suppliers in response to the transshipment request, the handshake request indicating the willingness of the one of the suppliers to provide the product as specified in the transshipment request and including information regarding the transshipment; and
a computing device configured to accept the handshake request, thereby initiating transshipment of the product from the one of the suppliers in accordance with the accepted handshake request.

8. The system of claim 1, wherein the information included in the transshipment request includes information identifying the product.

9. The system of claim 1, wherein the information included in the transshipment request includes information specifying the quantity of product requested for transshipment.

10. The system of claim 1, wherein the reward specified in the transshipment request indicates the reward payable to the supplier upon transshipment of the product.

11. The system of claim 1, wherein the information regarding the transshipment included in the handshake request specifies the cost of transshipment of the product.

12. The system of claim 1, further comprising a computing device configured to determine whether to accept the handshake request based on the information regarding the transshipment included in the handshake request.

13. Computer-readable code stored on a computer-readable medium that, when executed by a processor, performs a method for establishing transshipment of a product between stocking locations, the method comprising:
transmitting, by a computing device, a transshipment request to at least one supplier requesting transshipment of a product, the transshipment request including information regarding the product and specifying a reward for transshipment of the product;
receiving, by a computing device, a handshake request from one of the suppliers in response to the transshipment request, the handshake request indicating the willingness of the one of the suppliers to provide the product as specified in the transshipment request and including information regarding the transshipment; and
accepting, by a computing device, the handshake request, thereby initiating transshipment of the product from the one of the suppliers in accordance with the accepted handshake request.

14. The computer-readable code of claim 13, wherein the information included in the transshipment request includes information identifying the product.

15. The computer-readable code of claim 13, wherein the information included in the transshipment request includes information specifying the quantity of product requested for transshipment.

16. The computer-readable code of claim 13, wherein the reward specified in the transshipment request indicates the reward payable to the supplier upon transshipment of the product.

17. The computer-readable code of claim 13, wherein the information regarding the transshipment included in the handshake request specifies the cost of transshipment of the product.

18. The computer-readable code of claim 13, wherein the method further comprises determining, by a computing device, whether to accept the handshake request based on the information regarding the transshipment included in the handshake request.
